(19) United States
(12) Patent Application Publication
(10) Pub. No.: US 2008/0022306 A1
(43) Pub. Date: Jan. 24, 2008

(54) Revenue-Based Entertainment System

(76) Inventor: George B. Jennings, Boulder Creek, CA (US)

Correspondence Address: KENYON & KENYON LLP, RIVERPARK TOWERS, SUITE 600, 333 W. SAN CARLOS ST., SAN JOSE, CA, 95110, US

(21) Appl. No.: 11/733,107

(22) Filed: Apr. 9, 2007

Related U.S. Application Data
(60) Provisional application No. 60/744,656, filed on Apr. 11, 2006.

(51) Int. Cl. H04N 5/445

(52) U.S. Cl. 725/42

(57) ABSTRACT

A revenue-based entertainment system may facilitate the enjoyment and purchase of various digital media and the interaction with other users in various settings. An embodiment revenue-based entertainment may comprise a server, a customer device, a digital media-writing system, a printing apparatus, and an audio/visual system.

### RELATED APPLICATIONS

This application claims the benefit under 35 U.S.C. §119(e) of U.S. Provisional Application Ser. No. 60/744,656 filed on Apr. 11, 2006.

### BACKGROUND OF THE INVENTION

1. Field of the Invention

Aspects of the present invention relate generally to multi-media systems, and more particularly, to a revenue-based entertainment system facilitating, among other things, the enjoyment and purchase of various digital media and the interaction with other users in various settings (with the ability, among other things, to transfer digital media to either portable formats (e.g., CD, DVD, Flash, Blu-Ray, MP3, or over the Internet, etc.).

2. Description of the Related Art

With the continued increase in the power of computers, there is a growing interest in low-cost networks to deliver multi-media selections, such as video and audio material or other content. Entertainment venues, such as bars and amusement parks face growing demand for on-site video and audio storage and distribution capabilities.

Typically, processing, storing and distributing audio or video (in either static or streaming form) requires huge amounts of the storage infrastructure that may not always be available in, or accessible from, the setting in which the data is desired. Moreover, typical high-storage servers are extremely expensive and not particularly scalable. Therefore, it may be desirable in some instances to provide a distributed architecture wherein high-volume data types such as video or audio may be stored centrally and transmitted to various low-cost, multi-functional remote or local entertainment devices capable of providing commercially desirable functionalities.

### BRIEF DESCRIPTION OF THE DRAWINGS

FIG. 1 is a simplified block diagram illustrating components of an embodiment of a revenue-based entertainment system.

FIG. 2 is a simplified block diagram illustrating components of an embodiment of a customer device for use in conjunction with a revenue-based entertainment system.

FIG. 3 is an additional simplified block diagram illustrating components of an embodiment of a customer device having input/output ports.

FIG. 4 is a simplified flow diagram illustrating the use of one embodiment of a revenue-based entertainment system.

FIG. 5 is a simplified flow diagram illustrating the use of one embodiment of a revenue-based entertainment system set in a restaurant or bar.

FIG. 6 is a simplified flow diagram illustrating the use of one embodiment of a revenue-based entertainment system directed to karaoke.

FIG. 7 is a simplified flow diagram illustrating the use of one embodiment of a revenue-based entertainment system set in a retail store.

FIG. 8 is a simplified flow diagram illustrating the use of one embodiment of a revenue-based entertainment system set in a tourist attraction.

### DETAILED DESCRIPTION

Embodiments of a revenue-based entertainment system may generally comprise advertisement-enabled components facilitating enjoyment and purchase of various digital media and interaction with other users. In operation, a system and method as set forth herein may provide, among other things, the ability to sample and purchase myriad types of digital media and be employed in, for example, a restaurant/bar, a retail outlet, or a tourist attraction. Some embodiments may have utility in other settings as described below as well.

### A. Hardware Environment

Some embodiments of a revenue-based entertainment system may comprise a plurality of networked customer devices (described further below) coupled to a server. The “network” as described herein may operate as an extranet, in that it may comprise a network intranet (e.g., a local-area network (LAN), a wide-area network (WAN)) further connected to other networks. These other networks may include, for example, the Internet. It will be understood by those skilled in the art that communication over the network may involve suitable servers, routers and other components, as is dictated by the particular environment, and that the present disclosure is not intended to be limited to any particular network architecture or communications protocol. The term “user” as described herein may include any individual with access to the network.

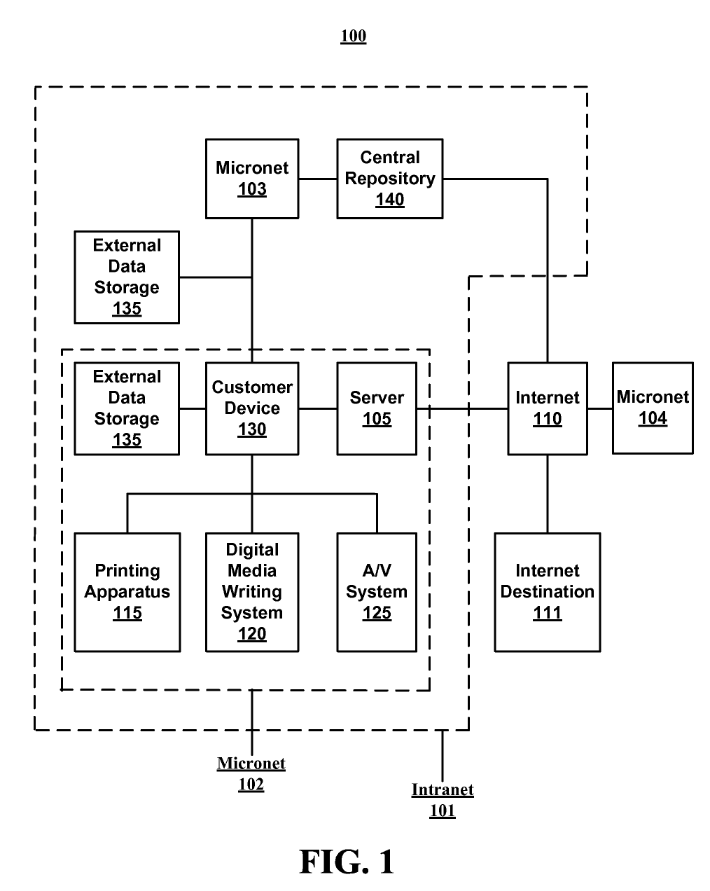

FIG. 1 is a simplified block diagram illustrating components of an embodiment of a revenue-based entertainment system. As illustrated, embodiment revenue-based entertainment system 100 may operate as a network as defined above, and may generally comprise intranet 101 connected to Internet 110. Intranet 101 may further comprise one or more micronets 102, 103, external storage device 135, or central repository 140. Micronet 102 may comprise, for example, server 105, a printing apparatus 115, a digital media-writing system 120, an audio-visual (A/V) system 125, and a customer device 130. The Internet 110 may be utilized to connect intranet 101 (comprising micronets 102, 103) to Internet destination 111, central repository 140 or micronet 104. In alternative embodiments, digital media-writing system 120, printing apparatus 115, and audio-visual system 125 may be part of server 105 itself, part of micronet 102 (e.g., FIG. 1), or located at any other location available over the network.

Server 105 may comprise, for example, but is not limited to, a personal computer, a mainframe computer, or the like. Server 105 may be embodied in or comprise any suitable network device capable of providing select data (i.e., data of interest to a user such as, for example, text, hypertext, photographs, video or audio data) for communication over the network. Server 105 may be connected to the Internet 110, for example, via broadband connection in any of various ways generally known in the art (e.g., cable, DSL, fiber, satellite, etc.), or via other communications technology and protocols developed and operative in accordance with known principles.

Server 105 may also include one or more internal data storage devices to store select data for communication to, for example, a customer device 130, a destination over the Internet 110 (e.g., and Internet Protocol (IP) address, an e-mail address), or digital media-writing system 120. Alternatively or additionally, server 105 may be coupled to external data storage device 135 (as part of either micronet 102 or intranet 101) to obtain select data for communication.

Select data stored on data storage devices (e.g., server 105, external data storage device 135 or a storage device located at a central repository 140) includes all types of “select media”, which are available for preview, play, and purchase. Select media items may include, for example, music, music videos, movies, video games, software, ringtones, photos, or similar data items that may be transmitted over the network. These select media may be maintained on the server 105 for retrieval by customer device 130, and routinely updated by, for example, downloading from a central repository 140 over the Internet 110. A “customer”, as used herein, is a user who may potentially conduct a commercial transaction over the network.

Server 105 may be connected to digital media-writing system 120; in operation, digital media writing system 120 may be capable of writing select data to various formats. These formats may include, but are not limited to, compact disc (CD), digital video disc (DVD), high-definition digital video disc (HD-DVD), Blu-ray, and flash media (e.g., Compact Flash, secure digital (SD), microSD, cell phone, Iphone™, Ipod, MP3 player, MemoryStick, etc.). Advertisements may be displayed on the written media, or housing for the written media.

Customer device 130 communicates over the network as described above. Customer device 130 is, in some ways, similar to a “thin-client,” as commonly understood by one of ordinary skill in the art. However, unlike a typical thin-client, customer device 130 may also allow more than simple interaction with a host computer.

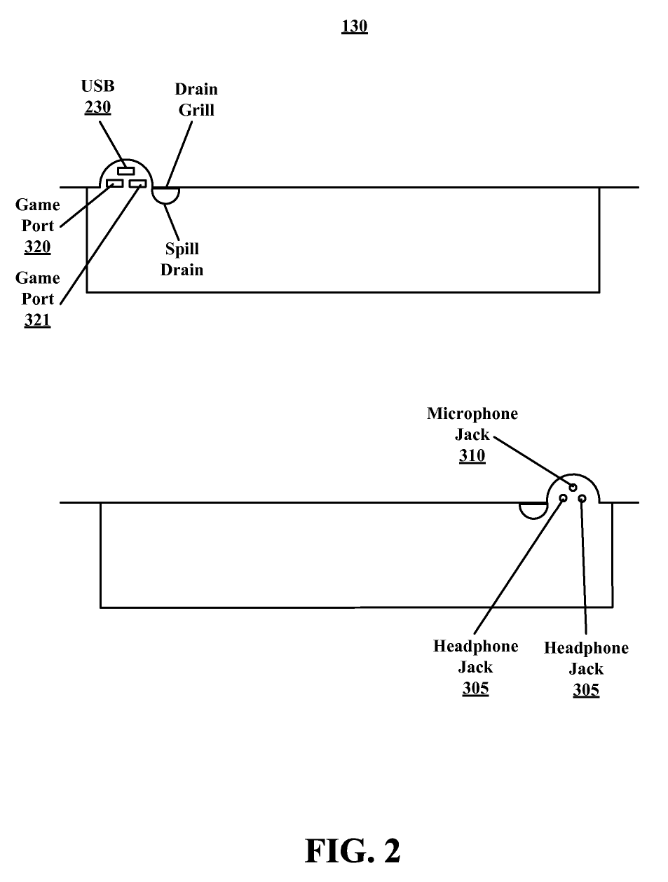

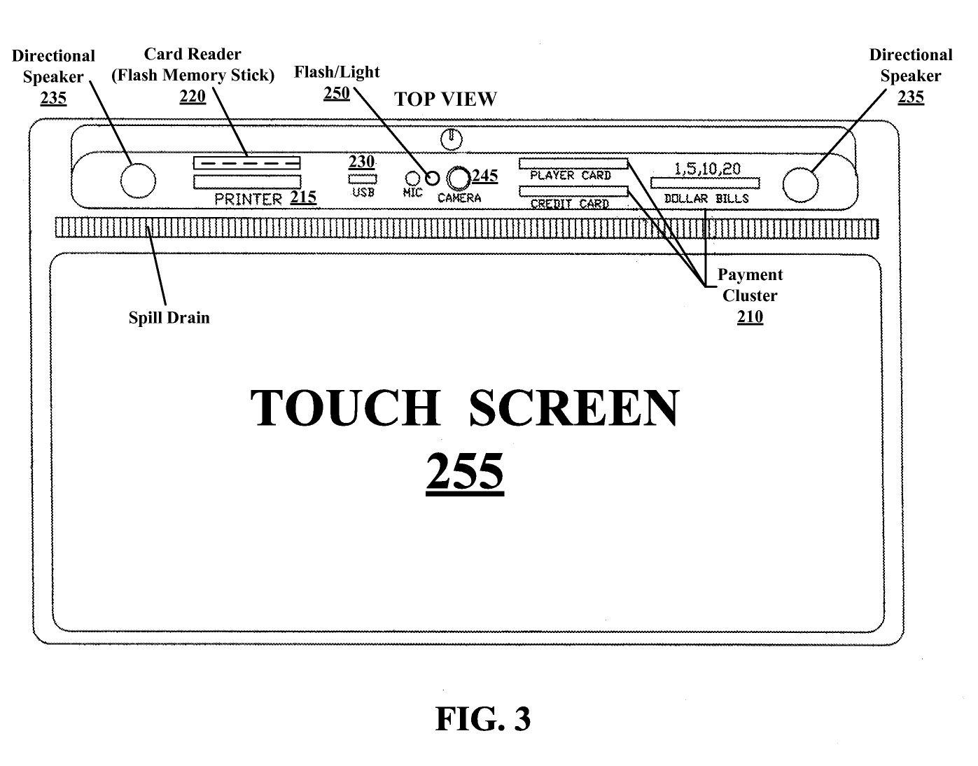

FIG. 2 is a simplified block diagram illustrating a side view of an embodiment of a customer device 130 comprising input/output ports. Customer device 130 may generally include, among other parts, an audio jack 305 (for headphones, etc.), microphone jack 310, port 230 and one or more game ports 320 and 321 (e.g., joysticks, controllers, etc.). While depicted in particular locations in FIG. 2, one versed in the art will appreciate these (and other) ports may be placed anywhere on the customer device 130 and in any combination. FIG. 3 is a simplified block diagram illustrating components of an embodiment customer device 130 comprising touch-screen 255 for use in conjunction with an embodiment of a revenue-based entertainment system. Additionally or alternatively, customer device 130 may include, for example, card readers 220 (e.g., Compact Flash, SD, microSD, MemoryStick, etc.) for connecting various devices, a FireWire/IEEE 1394 or USB port 230, bidirectional speaker ports 235A/B (see FIG. 2), and a digital camera port 245 (still and video), which may also include a light and/or flash mechanism 250 (e.g., an actual flash bulb, a bright LED, etc.)

In some embodiments, customer device 130 may employ a touch-screen 255. Touch-screen 255 may be waterproof. When touch-screen 255 is not in use, it may operate as an advertisement-delivery system (e.g., providing or displaying full screen ads or banner ads along portions of the screen). Touch-screen 255 may act as an advertisement-delivery system when in use as well, and may be browsed through the touch-screen 255. The advertising may also comprise services offered by the revenue-based entertainment system 100.

User browsing patterns or navigation history may be tracked, aggregated, and transmitted, for example, to advertisers or other third parties. This information may include advertisement content the user selected or viewed, the physical location (e.g., city and state) of customer device 130, and other industry-recognized demographics or relevant data such as payment method, usage statistics, etc.

Customer device 130 may contain a payment cluster 210, which may accept a plurality of currencies (e.g., cash or “points”, as explained below) to complete a transaction. These currencies may also be stored on, for example, credit cards, debit cards, and “player” or “membership” cards.

The player or membership cards may be distributed by the establishment in which revenue-based entertainment system 100 is deployed and may be used for various purposes. For example, the cards may store a cash amount or be used to store and transfer “points”. These points may be used to, for example, play an establishment-wide game on customer device 130. The cards may also store customer information, history, or personal profiles, which may be used for social interaction through customer device 130. Users may enter such information through the customer device 130 at time of use, transfer it from other social networking sites (e.g., My Space®), or retrieve it from a server (e.g., server 105) deployed in the establishment by entering a login and password. Users may interact by, for example, identifying other users on the network and communicating select data with them by, for example, transmitting messages, music files, or video files, etc., transferring points, or transmitting select data to an external destination (e.g., an Internet address or a mobile phone).

Payment cluster 210 may also have the ability to print a receipt of the customer's purchase transactions through printing apparatus 215. Printing apparatus 215 may also be configured to print select data available, for example, over the Internet 110. Such receipts contain information identifying the customer and the purchase (using Universal Price Code (UPC) or other unique indicia), and may also include advertisement content, coupons, etc. Receipts may also be pre-printed, on demand printed, or location printed with coupons, advertisement content, or other information.

In certain table-top embodiments, customer device 130 may also contain an integrated spill drain to allow spilled liquid to fall away easily and to protect the electronics inside. A drain is illustrated in FIG. 2 (element 225) and FIG. 3 (element 330).

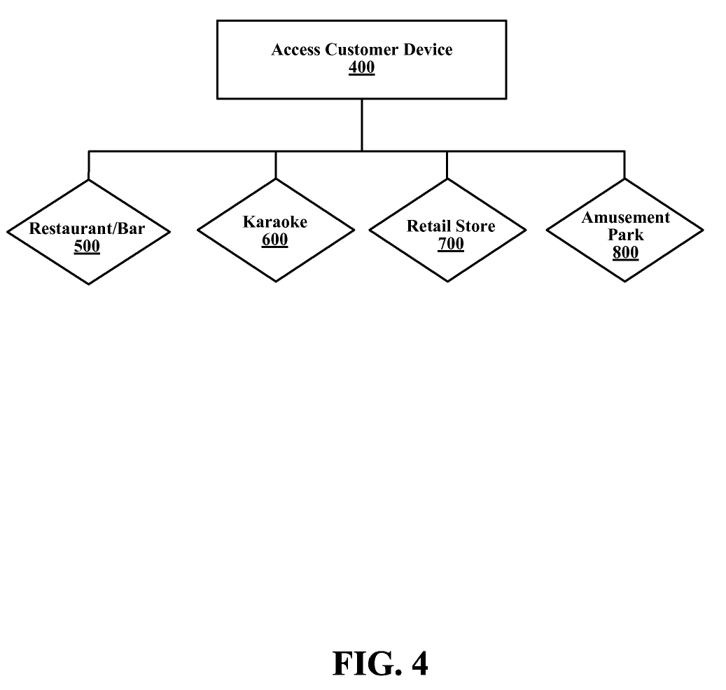

FIG. 4 is a simplified flow diagram illustrating various functionalities of embodiment revenue-based entertainment systems (such as revenue-based entertainment system 100 described in detail above with reference to FIG. 1). Block 500 represents the use of one embodiment of a revenue-based entertainment system set in a restaurant or bar. Block 600 represents the use of one embodiment of a revenue-based entertainment system directed to karaoke. Block 700 represents the use of one embodiment of a revenue-based entertainment system set in a retail store. Block 800 represents the use of one embodiment of a revenue-based entertainment system set in an tourist attraction. General descriptions as applied to specific settings are detailed below. It should be understood that individual features of a first embodiment may be implemented in a second embodiment.

i. Restaurant or Bar

A customer device (such as customer device 130 described in detail above with reference to FIGS. 1-3) may have multiple implementations in the restaurant or bar setting. For example, the customer device may be mounted on, for example, table or bar top. The server (such as server 105 described in detail above with reference to FIG. 1) may be located either at the point-of-service, the register, or some other location. The customer device may be a stand-alone device (e.g., directly above a rack of CDs in a music store or a kiosk with a digital advertising display, etc.) or part of the server if the server is located at the point of service. In this instance, the customer device may be either flush-mount with the bar top or table, or may be of such a low-profile as to be easily moveable and manageable. Flush mount customer device may also be configured to “drop-in” for easy installation, maintenance, replacement and transport, while providing or minimizing damage to the table or bar top which houses it (other than original installation). A security device (e.g., a cable) may tether the customer device to, for example, the table or bar top, or a wall, to prevent theft. Through the customer device, the customer may have access to the panoply of entertainment options offered by the establishment. These include, but are not limited to, games, music, videos, software, karaoke, movies, TV, communication with other users, and Internet access. Select data purchased through the revenue-based entertainment system may be written to physical media (i.e., CD, DVD, flash media, cell phones, Ipods or other MP3 players, etc.) by a digital media writing system (such as digital media writing system 120 described in detail above with reference to FIG. 1) described in detail above with reference to FIG. 1) or e-mailed or otherwise transmitted electronically (as described above). Similarly, select data (such as, for example, a karaoke performance (as discussed below)) may be transmitted to the establishment's A/V system (such as A/V system 125 described in detail above with reference to FIG. 1).

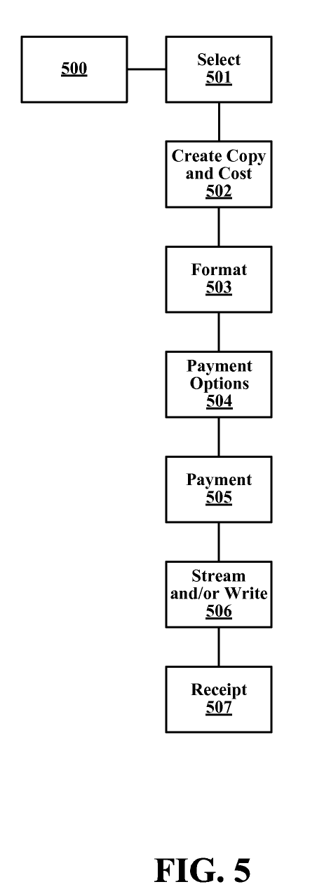

FIG. 5 is a simplified flow diagram illustrating the use of one embodiment of a revenue-based entertainment system (e.g., revenue-based entertainment system 100 described in detail with reference to FIG. 1) set in a restaurant or bar. The arrangement of the blocks in FIG. 5 does not necessarily imply a particular order or sequence of events, nor is it intended to exclude other possibilities. At decision block 501, the customer uses the touch-screen on the customer device (such as customer device 130 described in detail above with reference to FIG. 1) to select from the menu a music video to be purchased. At block 502, the customer device displays or otherwise indicates the video will cost a specific amount to purchase, and indicates that the user will be able to create a copy of the video, if desired. At block 503, the customer device offers format options, such as CD, DVD, flash media, cell phones, Ipods or other MP3 players, etc. The customer selects a format. At block 504, the customer device presents the customer with various payment options, where such options may include cash, credit card, etc. In alternative embodiments, the presentation in block 504 may occur before the format selection in block 503. At decision block 505, the customer selects a payment option and pays. At block 506, the customer device streams the video from the server (such as server 105 described in detail above with reference to FIG. 1), which houses the video in its select media library, for display on the customer device. The customer may watch the video as it is streamed to the customer device; additionally or alternatively, the customer may have a digital media writing system (such as digital media writing system 120 described in detail above with reference to FIG. 1) write it to portable media (e.g., CD, DVD, flash media, cell phones, Ipods or other MP'3 players, etc.) for viewing at a later time. The customer device prints a receipt of the transaction, identifying, for example, the customer and the items purchased. At block 507, the user takes his receipt and newly-written CD.

The panoply of entertainment options offered through the customer device may also include games. These games may be played against other users (e.g., on separate customer devices) within the establishment, or other users over the Internet.

The establishment (e.g., the restaurant or bar) may set up various tournaments through which prizes may be awarded. These prizes may materialize as “points” redeemable for other prizes. These prizes may include, for example, the ability to select songs and have them transferred to the A/V system, recorded to some physical media format, and/or stored on the server or transferred to a player or membership card for future use/redemption.

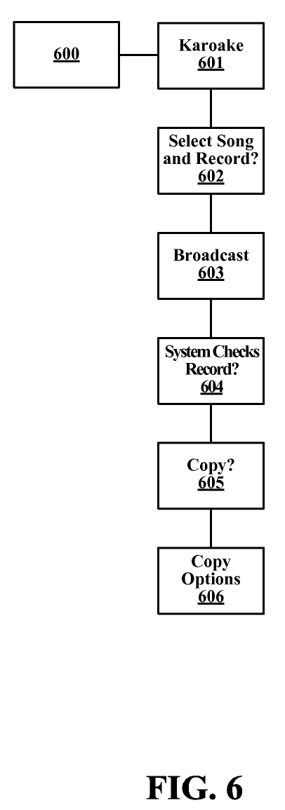

FIG. 6 is a simplified flow diagram illustrating the use of one embodiment of a revenue-based entertainment system (e.g., revenue-based entertainment system 100 described in detail with reference to FIG. 1) for karaoke. The arrangement of the blocks in FIG. 6 does not necessarily imply a particular order or sequence of events, nor is it intended to exclude other possibilities. At decision block 601, the customer selects the karaoke option from the menu on the customer device (such as customer device 130 described in detail above with reference to FIGS. 1-3). At decision block 602, the customer selects a song, and indicates whether the performance should be recorded. At block 603, the song begins to play, and the server (such as server 105 described in detail above with reference to FIG. 1) broadcasts the music through the A/V system (such as A/V system 125 described in detail above with reference to FIG. 1) and streams the lyrics of the song to the customer device. The microphone and the digital camera on the customer device allow broadcast of the performance over the establishment's A/V system or the network. At block 604, the device determines whether the customer chose to have his performance recorded (block 602). In alternative embodiments, block 604 may precede block 603. At block 605, the customer device presents options regarding the creation of a copy. At decision block 606, the customer selects to have the performance either, for example, written to physical media (e.g., CD, DVD, flash card, etc.), transferred to a portable device (e.g., MP3 player, mobile phone, etc.) or e-mailed. Additional processes, such as, for example, securing payment and documentation (i.e., receipt creation and printing) may be similar to that described in the previous example.

ii. Retail Store

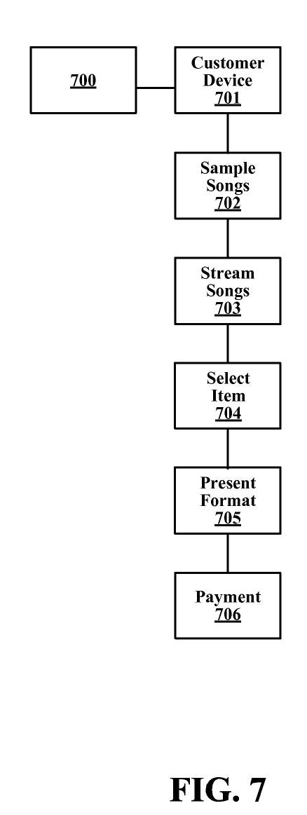

FIG. 7 is a simplified flow diagram illustrating the use of one embodiment of a revenue-based entertainment system (e.g., revenue-based entertainment system 100 described in detail with reference to FIG. 1) set in a retail store. The arrangement of the blocks in FIG. 7 does not necessarily imply a particular order or sequence of events, nor is it intended to exclude other possibilities. At block 701, the customer engages the customer device (such as customer device 130 described in detail above with reference to FIGS. 1-3) through its touch-screen and, at decision block 702, selects parts of various songs to listen to as she decides which to buy. At block 703, songs are streamed from the server (such as server 105 described in detail above with reference to FIG. 1), which may be either connected directly to the customer device if the server is at the point of service or is in some other location. At decision blocks 704, the customer selects an item (e.g., a single song, multiple songs from different albums, an entire album, etc.). At block 705, the customer is presented with various media formats to select, and the customer selects the desired media format (e.g., CD, DVD, flash media, etc.). At block 706, customer pays using any of the accepted payment methods built into the customer device (e.g., credit card, cash, etc.) and a receipt is printed. In alternative embodiments, block 706 may precede block 705. Additional processes, such as, for example, securing payment and documentation (i. e., receipt creation and printing) may be similar to that described in the previous examples.

iii. Tourist Attraction

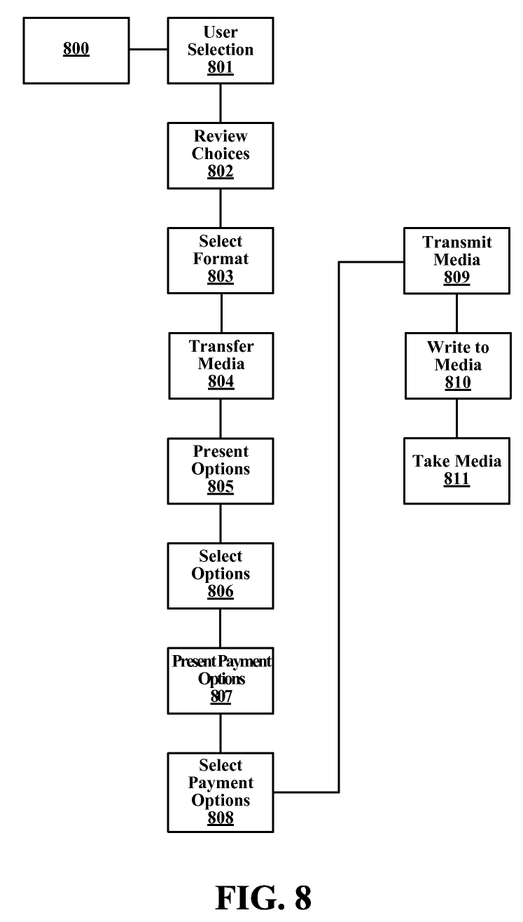

Another embodiment of a revenue-based entertainment system may be directed to a tourist attraction. FIG. 8 is a simplified flow diagram illustrating the use of one embodiment of a revenue-based entertainment system (such as revenue-based entertainment system 100 described in detail with reference to FIG. 1) set in an tourist attraction. The arrangement of the blocks in FIG. 8 does not necessarily imply a particular order or sequence of events, nor is it intended to exclude other possibilities. At decision block 801, the customer selects from its touch-screen menu of a customer device (such as customer device 130 described in detail above with reference to FIGS. 1-3) the option to have digital photos written to physical media. At block 802, she reviews the choices regarding the creation of the copy, such as, desired format. At decision block 803, she selects, for example, a DVD format. At block 804, she inserts her media storage (e.g., Compact Flash, etc.) housing the pictures into the correct card reader on the customer device or connects the camera using one of the various ports on the customer device. Alternatively, she may call a free number on the customer device and transfer images from her mobile phone. In alternative embodiments, block 804 may precede block 803. At block 805, the customer device reads the card and offers the customer more options (e.g., disk layout, presentation). At decision block 806, the customer selects the desired options. At block 807, the customer is presented with payments options using the customer device's payment cluster (e.g., credit card, cash, etc.). At decision block 808, the customer selects a payment option and pays. At block 809, the customer device sends the digital photos to the server where, at block 810, the server writes the digital photos to the selected physical media and the customer device prints a receipt. At block 811, if the customer device is coupled directly to the server, the customer can take her DVD immediately after it is created. If the customer device is located in an area separate from the digital media-writing system, the customer may pick up her DVD at the digital media-writing system. Alternatively, the customer could have chosen to have the media sent to her e-mail address or stored on the server for later retrieval from home; in such case the receipt would be used to authorize delivery.

While the present invention has been described with reference to the aforementioned applications, this description of the preferred embodiments is not meant to be construed in a limiting sense. It shall be understood that all aspects of the present invention are not limited to the specific depictions, configurations or dimensions set forth herein which depend upon a variety of principles and variables. Various modifications in form and detail of the disclosed apparatus, as well as other variations of the present invention, will be apparent to a person skilled in the art upon reference to the present disclosure. It is therefore contemplated that the appended claims shall cover any such modifications or variations of the described embodiments as falling within the true spirit and scope of the present invention.

What is claimed is:

1. A revenue-based entertainment system comprising:
a customer device to access and select data and to display advertisement content for a user;
a digital media-writing system connected to the customer device to write the select data to physical media;
a printing apparatus connected to the customer device to print select data or transaction receipts;
an audio/visual system to broadcast the select data;
a server to store and deliver the select data wherein the server accesses select data through at least one of an external data storage device and a central repository; and
an intranet to connect the customer device and the server.

2. The system of claim 1, wherein the intranet is further connected to the Internet

3. The system of claim 1, wherein the customer device is one of a plurality of customer devices.

4. The system of claim 1, wherein the server is one of a personal computer or a mainframe computer.

5. The system of claim 1, wherein the server transmits select data over the Internet to an Internet destination.

6. The system of claim 1, wherein the select data is a select media item displayed on the customer device for preview, play, or purchase.

7. The system of claim 1, wherein the select data is a select media item stored on one of the server, the external data storage, or the central repository.

8. The system of claim 1, wherein the server tracks use data associated with access of the select data and the advertisement content.

9. The system of claim 1, wherein the server aggregates use data associated with access of the select data and the advertisement content.

10. The system of claim 1, wherein the server transmits use data associated with access of the select data and the advertisement content.

11. The system of claim 1, wherein the customer device comprises a payment cluster to accept a plurality of currencies to complete a transaction.

12. The system of claim 6, wherein the digital media writing system writes the select media item in one of a plurality of data formats.

13. The system of claim 6, wherein the digital media writing system writes the select media data in a format selected from the group consisting of compact disc, digital video disc, high-definition digital video disc, Blu-ray, and flash media formats.

14. The system of claim 1, wherein the customer device comprises a plurality of input/output ports.

15. The system of claim 1, wherein the customer device comprises an audio jack, a microphone jack, a USB port, a game port, a card reader, a Universal Serial Bus port, a FireWire/IEEE 1394 port, a speaker port, a microphone port, and a digital camera port.

16. The system of claim 1, wherein the customer device comprises a spill drain.

17. The system of claim 1, wherein the customer device is a stand-alone device.

18. The system of claim 1, wherein the customer device is flush-mount to a surface and configured to be a drop-in device.

19. The system of claim 1, wherein the customer device is tethered to the table or bar top.

20. The system of claim 2, wherein a user uses interacts with another user on the network.

21. The system of claim 1, wherein the server transmits select data to an external destination.

22. The system of claim 1, wherein the customer device comprises a touch-screen user interface.
